(19) United States
(12) Patent Application Publication
(10) Pub. No.: US 2015/0244105 A1
(43) Pub. Date: Aug. 27, 2015

(54) ELECTRICAL CONNECTOR ASSEMBLY WITH MAGNETIC ELEMENT

(71) Applicant: LOTES CO., LTD, Keelung City (TW)

(72) Inventor: Jian Min Peng, Keelung City (TW)

(21) Appl. No.: 14/451,096

(22) Filed: Aug. 4, 2014

(30) Foreign Application Priority Data
Feb. 25, 2014 (CN) 201420080065.7

(51) Int. Cl. H01R 13/62

(52) U.S. Cl. CPC H01R 13/6205

(57) ABSTRACT

An electrical connector assembly includes a plug connector and a receptacle connector mated in a forward and backward direction. The plug connector includes a body having a first mating surface and a front surface disposed at a front end of the first mating surface, and at least one first magnetic element disposed on the front surface. The receptacle connector includes a seat, a second magnetic element disposed on the seat, and a second tongue extending backward from the seat and having a second mating surface. The second magnetic element is located at a front side of the second mating surface. The first magnetic element is magnetically attracted to the second magnetic element by crossing the second mating surface, so that the second mating surface is electrically connected with the first mating surface.

### CROSS-REFERENCE TO RELATED APPLICATION

This non-provisional application claims priority under 35 U.S.C. §119(a) on Patent Application No. 201420080065.7 filed in P.R. China on Feb. 25, 2014, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The invention relates to an electrical connector assembly, and more particularly to an electrical connector assembly for magnetic connection.

### BACKGROUND OF THE INVENTION

An existing cooperative receptacle and plug connector assembly includes a plug connector and a receptacle connector. The plug connector includes a body, the body extends to form a tongue, and multiple terminals are disposed on the tongue. A case covers on the periphery of the tongue, and a buckling portion is provided on the case. The receptacle connector includes a receptacle body. A metal case is disposed on the periphery of the receptacle body to form an insertion space, and an elastic buckling arm is disposed on the metal case. The tongue of the plug connector is inserted in the mating space and engaged with the elastic buckling arm through the buckling portion on the case, which ensures electrical connection between the plug connector and the receptacle connector.

However, because the plug connector and the receptacle connector are cooperatively mated through the buckling structure of the buckling portion and the elastic buckling arm designed on the cases thereof, it is rather difficult to connect and separate the two connectors and the operation is inconvenient. Besides, with the developing trend of a smaller product, the space is getting smaller and the buckling structure is becoming thinner, so that the buckling structure is easy to be damaged. Moreover, unintentional touch of a cable terminal of the plug connector in use may cause poor contact of the plug connector and the receptacle connector, but the buckling portion and the elastic buckling arm cannot be disconnected immediately, which results in poor signal transmission, affects information transmission, and even causes the danger of electric sparks.

Therefore, a heretofore unaddressed need exists in the art to address the aforementioned deficiencies and inadequacies.

### SUMMARY OF THE INVENTION

In one aspect, the present invention is directed to a connector that is simple in structure, easy in operation, and stable in electrical connection.

In one embodiment, the electrical connector assembly includes a plug connector and a receptacle connector mated in a forward and backward direction. The plug connector includes a body and at least one first magnetic element. The body has a first mating surface and a front surface disposed at a front end of the first mating surface. The at least one first magnetic element is disposed on the front surface. The receptacle connector is located in front of the plug connector, and includes a seat and a second tongue. A second magnetic element is disposed on the seat and magnetically attracted to the first magnetic element, so that the plug connector and the receptacle connector are fixed. The second tongue extends backward from the seat and has a second mating surface. The second magnetic element is located at a front side of the second mating surface. The first magnetic element is magnetically attracted to the second magnetic element by crossing the second mating surface, so that the second mating surface is electrically mated with the first mating surface.

In one embodiment, the front surface is perpendicular to the first mating surface.

In one embodiment, multiple first terminals are disposed on the body, and the first magnetic element is located at front ends of the first terminals.

In one embodiment, each first terminal has a first contact portion, the first contact portion is perpendicular to the first magnetic element, and when the plug connector is mated with the receptacle connector, the insertion depth of the first magnetic element in the receptacle connector is greater than that of the first contact portions.

In one embodiment, the first contact portion is disposed on and exposed out of the first mating surface, the first contact portion is bent forwardly and downwardly and extends to form a bent portion, and the bent portion is disposed in the body.

In one embodiment, the first magnetic element is plated on a front end of the bent portion.

In one embodiment, the second tongue is provided with second terminals, each second terminal has a second contact portion, and the second magnetic element is located in front of the second contact portions in a forward and backward direction.

In one embodiment, the second terminals and the second magnetic element are disposed on the same side of the second tongue.

In one embodiment, a shielding case is disposed on the periphery of the seat, the shielding case has a back flange, and the back flange is covered on a back end of the second tongue.

In another aspect, the present invention is directed to an electrical connector assembly.

In one embodiment, the electrical connector assembly includes a plug connector and a receptacle connector mated with the plug connector in a forward and backward direction. The plug connector includes a body, multiple first terminals, and at least one first magnetic element. The body has a first mating surface and a front surface disposed at a front end of the first mating surface. Each of the multiple first terminals has a first contact portion. The first contact portion is disposed on the first mating surface. The at least one first magnetic element is disposed on the front surface. The receptacle connector includes a seat having a second tongue and multiple second terminals. Each of the multiple second terminals has a second contact portion. The second contact portion is disposed on the second tongue. When the plug connector is mated with the receptacle connector, the first magnetic element is magnetically attracted to the second magnetic element by crossing the second contact portions, so that the first contact portions electrically contact the second contact portions.

In one embodiment, the first magnetic element is perpendicular to the first contact portions.

In one embodiment, the second terminals and the second magnetic element are disposed on the same side of the second tongue.

In one embodiment, each first contact portion is bent forwardly and downwardly, and extends to form a bent portion, and the first magnetic element is plated on a front end of the bent portion.

Compared with the related art, certain embodiments of the present invention, among other things, have the following beneficial advantages.

(1) In the electrical connector assembly, magnetic attraction between the first magnetic element and the second magnetic element enables electrical connection between the receptacle connector and the plug connector, which is easy for mating and convenient in operation.

(2) By using connection through magnetic attraction between the magnetic elements to replace connection through engagement of buckling members, the structure is simple, and the simplified structure of the connector is more suitable for the developing trend of being smaller and thinner.

(3) By using connection through magnetic attraction between the magnetic elements, unintentional touch of the plug connector and the receptacle connector in use may cause immediate disconnection easily, which avoids problems of poor contact such as intermittent contact.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic view of an electrical connector assembly according to one embodiment of the present invention.

FIG. 2 is a schematic three-dimensional exploded view of a plug connector in the electrical connector assembly according to one embodiment of the present invention.

FIG. 3 is a schematic three-dimensional exploded view of a receptacle connector in the electrical connector assembly according to one embodiment of the present invention.

FIG. 4 is a schematic cross-sectional view of the electrical connector assembly before mating according to one embodiment of the present invention.

FIG. 5 is a schematic cross-sectional view of the electrical connector assembly after mating according to one embodiment of the present invention.

FIG. 6 is a schematic view of another embodiment of the electrical connector assembly according to one embodiment of the present invention.

FIG. 7 is a schematic cross-sectional view of another embodiment of the electrical connector assembly before mating according to one embodiment of the present invention.

FIG. 8 is a schematic cross-sectional view of another embodiment of the electrical connector assembly after mating according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

To facilitate description and understanding, it is defined that in a three-dimensional coordinate system in the figures, an X-axis represents a forward direction, a Y-axis represents a rightward direction, and a Z-axis represents an upward direction; the invention is not limited to the directional description.

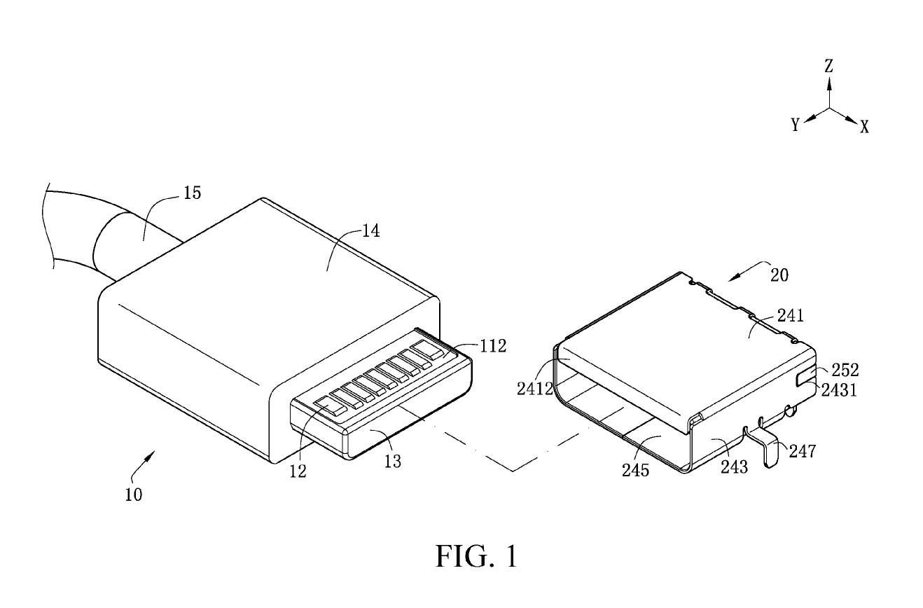

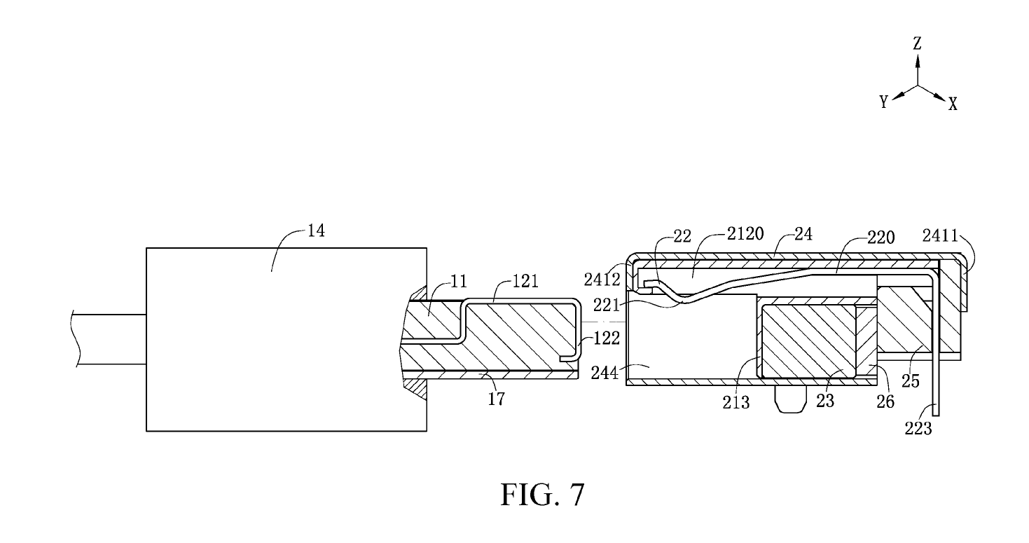

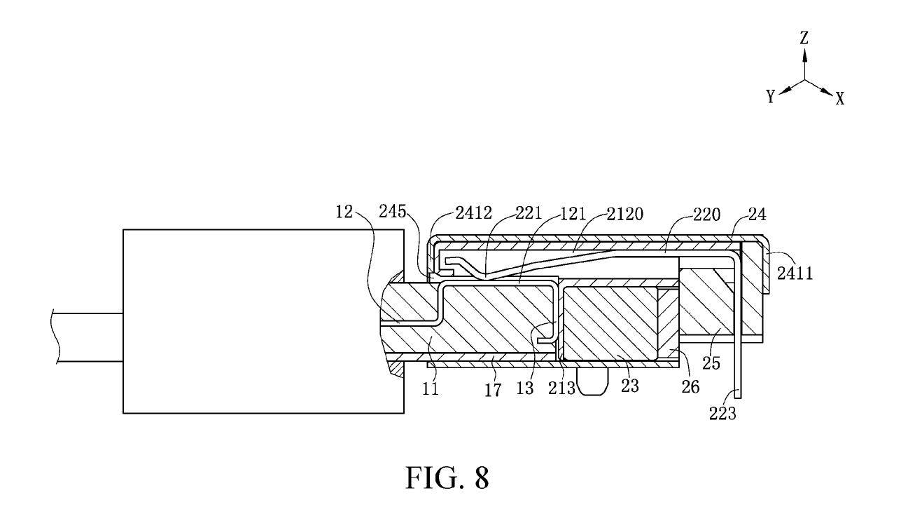

The description will be made as to the embodiments of the present invention in conjunction with the accompanying drawings in FIGS. 1-8. In accordance with the purposes of this invention, as embodied and broadly described herein, this invention, in one aspect, relates to an electrical connector.

Referring to FIGS. 1-3, in one embodiment, the electrical connector assembly of the present invention includes a plug connector 10 and a receptacle connector 20 mated with the plug connector 10 in a forward and backward direction. The receptacle connector 20 is located in front of the plug connector 10. The plug connector 10 includes a body 11, multiple first terminals 12 disposed on the body 11, at least one first magnetic element 13, and an insulating case 14 and cables 15 disposed on the periphery of the body 11. The receptacle connector 20 includes a seat 21, multiple second terminals 22 assembled to the seat 21, a second magnetic element 23, a filling member 25, a metal plate 26, and a shielding case 24 covered on the seat 21.

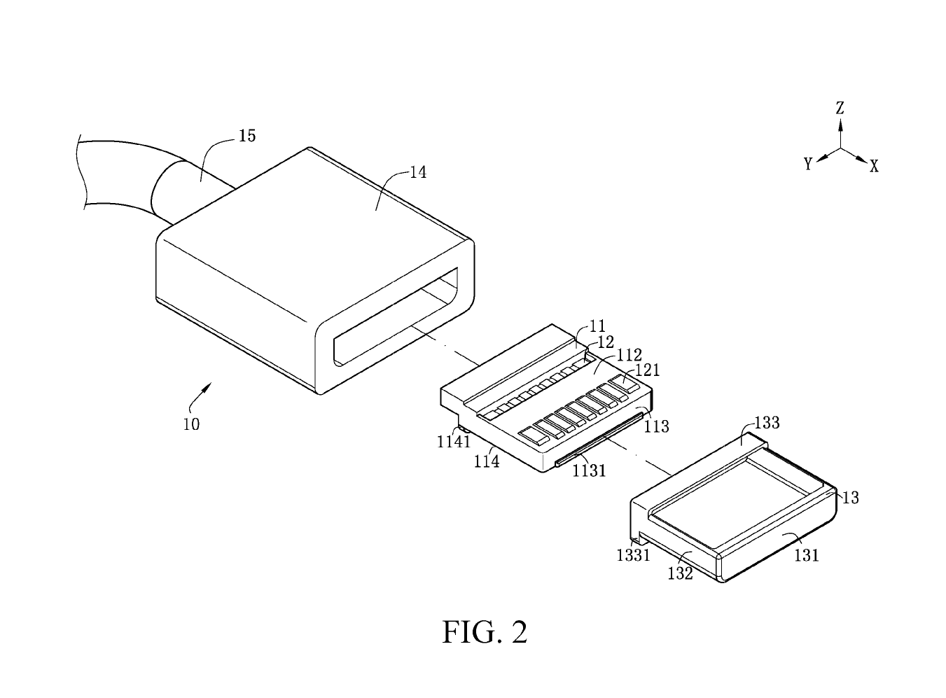

Referring to FIG. 1 and FIG. 2, the plug connector 10 includes the body 11. The body 11 extends forward to form a first mating surface 112. A front surface 113 is disposed at a front end of the first mating surface 112, and a bottom surface 114 is provided opposite to the first mating surface 112. The front surface 113 and the first mating surface 112 are disposed perpendicular or oblique to each other. In this embodiment, the front surface 113 is perpendicular to the first mating surface 112, and in other embodiments, the front surface 113 and the first mating surface 112 may also be inclined surfaces at an acute angle or obtuse angle. The front surface 113 protrudes forward to form a rib 1131. The bottom surface 114 extends outward in a direction perpendicular to the forward and backward direction to form a stopping block 1141. A back end of the body 11 extends backward to form multiple accommodating slots (not shown) for receiving the connection part of the first terminals 12 and the cables 15.

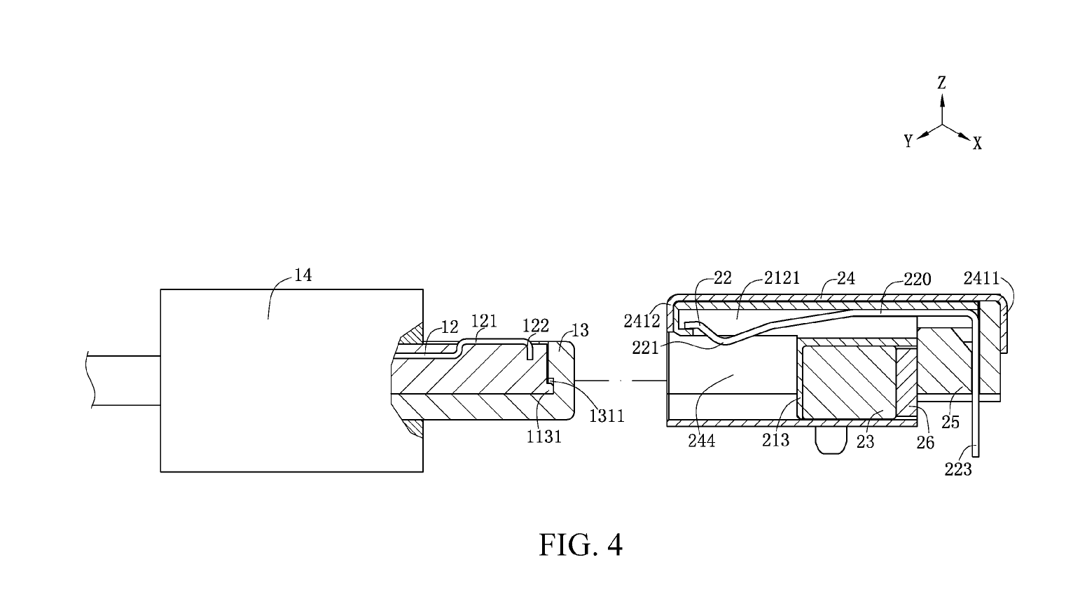

Referring to FIG. 2 and FIG. 4, the body 11 includes multiple first terminals 12 which are formed by punching a metal plate. Each first terminal 12 has a first contact portion 121. The first contact portion 121 is bent forwardly and downwardly, and extends to form a bent portion 122, and the first contact portion 121 is bent backward and extends to form a rear portion (not shown). The first terminals 12 are embedded in the body 11. The first contact portions 121 are exposed out of the first mating surface 112, and the bent portions 122 are disposed in the body 11. In other embodiments, the first terminals 12 may also be assembled in the body 11, so that the first terminals 12 are stably fixed to the body 11. The rear portions are received in the accommodating slots (not shown), and the cables 15 are respectively electrically connected to the rear portions (not shown).

Referring to FIG. 2 and FIG. 4, the insulating body 11 includes a first magnetic element 13. The first magnetic element 13 is a magnetic metal frame and has a front side surface 131. The front side surface 131 is a magnetized surface made of a magnetic metal element by using a single-sided multipolar magnetizing manner. In another embodiment, the front side surface 131 may also be a magnet, or a ferromagnetic material, or a magnetized surface made of a magnetic metal element by using a single-sided unipolar magnetizing manner. A groove 1311 is provided on an inner side of the front side surface 131. The front side surface 131 is bent backward and extends to form two opposite side surfaces 132. The two side surfaces 132 are connected through a retaining surface 133. The retaining surface 133 is perpendicular to the front side surface 131, and the retaining surface 133 extends outward in a direction parallel to the front side surface 131 to form a retaining block 1331.

Referring to FIG. 1 and FIG. 2, when the plug connector is assembled, the first terminals 12 and the body 11 are integrally embedded. The first contact portions 121 are exposed out of the first mating surface 112. The bent portions 122 are disposed in the body 11. The rear portions of the terminals 12 are exposed out of the accommodating slots (not shown) and are electrically connected to the cables 15. The first magnetic element 13 is assembled to the body 11 from the front surface 113, so that the first magnetic element 13 is disposed on the front surface 113, and the first magnetic element 13 is located at front ends of the first terminals 12. Therefore, the rib 1131 is assembled into the groove 1311, the retaining block 1331 rests on the stopping block 1141, and the retaining surface 133 is retained to the back end of the body 11. The first mating surface 112 is exposed out of the first magnetic element 13, the first magnetic element 13 is perpendicular to the first mating surface 112, and the first magnetic element 13 is also perpendicular to the first contact portions 121. The body 11 and the first magnetic element 13 are assembled and then covered by an insulating case 14 on the periphery, for protecting the connection part of the first terminals 12 and the cables 15.

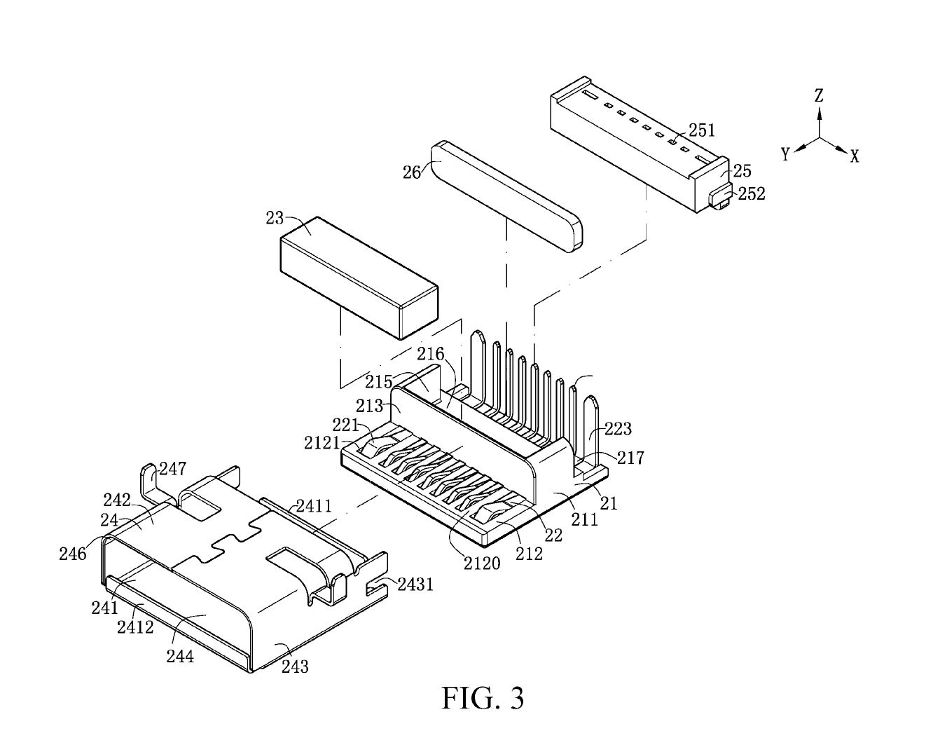

Referring to FIG. 3 and FIG. 4, the X-axis in the coordinate system represents the forward direction, the seat 21 includes a base portion 211. The base portion 211 extends backward in a forward and backward direction to form a second tongue 212. The second tongue 212 has a second mating surface 2120. Multiple second receiving slots 2121 are provided on the second mating surface 2120. The base portion 211 extends in a direction perpendicular to the second tongue 212 to form a wall portion 213. The wall portion 213 is located in front of the second tongue 212. The wall portion 213 is formed with a slot 215 on the base portion 211. A partition board 216 is provided between the slot 215 and the second receiving slots 2121 to separate the slot 215 from the second receiving slots 2121. A slot opening 217 is provided at a front end of the base portion 21, and a step is formed between the slot opening 217 and the slot 215.

Referring to FIG. 3 and FIG. 4, the second magnetic element 23 is received in the slot 215, and the second magnetic element 23 is located at a front side of the second mating surface 2120. The second magnetic element 23 is a magnet. In other embodiments, the second magnetic element 23 may also be a ferromagnetic material. A metal plate 26 is disposed in front of the second magnetic element 23.

Referring to FIG. 3, a filling member 25 is assembled at a front end of the seat 21. The filling member 25 has multiple through-holes 251 that penetrate the filling member 25 in a perpendicular direction, where the perpendicular direction is vertical to the forward and backward direction. Two opposite sides of the filling member 25 are each provided with a protruding block 252.

Referring to FIG. 3 and FIG. 4, the X-axis in the coordinate system represents the forward direction. The second terminals 22 are received in the second receiving slots 2121. The second terminals 22 are formed by punching a metal plate, and each second terminal 22 includes a retaining portion 220. The retaining portion 220 extends backward to form a second contact portion 221. The second contact portion 221 is provided with a bent elastic arm. The retaining portion 220 extends forward and is bent to form a second welding portion 223. The second terminals 22 are mounted in the second receiving slots 2121 from in front of the seat 21. The retaining portions 220 are located between the partition board 216 and the second receiving slots 2121. The second contact portions 221 are assembled to the second tongue 212 along the second receiving slots 2121 and are exposed out of the second mating surface 2120. The second welding portions 223 pass through and extend out of the through-holes 251.

Referring to FIG. 3 and FIG. 4, a shielding case 24 is covered on the seat 21. The shielding case 24 is formed by punching and bending a metal plate, and has a top surface 241, a bottom surface 242, and two opposite side surfaces 243. The top surface 241, the bottom surface 242 and the two opposite side surfaces 243 form a receiving space 244. Front and back ends of the top surface 241 respectively extend to form a front flange 2411 and a back flange 2412. The connection part of the bottom surface 242 and the two side surfaces 243 has a round angle or an inverted angle 246. The center parts of the two opposite side surfaces 243 extend downward to form two welding pins 247. Front ends of the two opposite side surfaces 243 are each provided with a gap 2431 for receiving the protruding block 252.

Referring to FIG. 3 and FIG. 4, when the receptacle connector 20 is assembled, the second terminals 22 are mounted on the second tongue 212, and the second contact portions 221 are disposed in the second receiving slots 2121 and are exposed out of the second mating surface 2120. The second magnetic element 23 is mounted in the slot 215. The second magnetic element 23 and the second terminals 22 are all disposed on the same side of the second tongue 212. The second magnetic element 23 is located in front of the second contact portions 221. The filling member 25 is disposed in the slot opening 217. The second welding portions 223 penetrate the through-holes 251. The metal plate 26 is disposed between the second magnetic element 23 and the filling member 25. The shielding case 24 is covered on the seat 21, so that the second tongue 212 is disposed in the receiving space 244. The back flange 2412 is covered on a back end of the second tongue 212, the front flange 2411 is covered on the filling member 25, and the front flange 2411 and the back flange 2412 enable the seat 21 and the filling member 25 to be stably assembled.

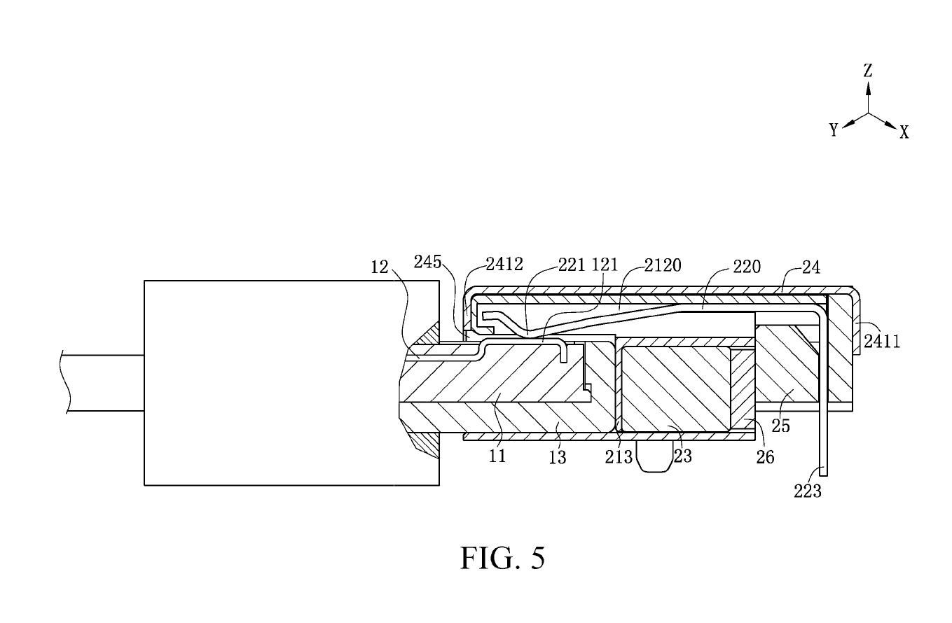

Referring to FIG. 4 and FIG. 5, when the plug connector 10 is fitted with the receptacle connector 20, the body 11 is partially inserted in the receiving space 244, and the first magnetic element 13 is magnetically attracted to the second magnetic element 23 by crossing the second mating surface 2120, so that the first mating surface 112 is electrically connected to the second mating surface 2120. In this manner, the insertion depth of the first magnetic element 13 in the receptacle connector 20 is greater than that of the first contact portions 121, so that the first contact portions 121 and the second contact portions 221 are in stable electrical contact, which ensures electrical conduction between the plug connector 10 and the receptacle connector 20.

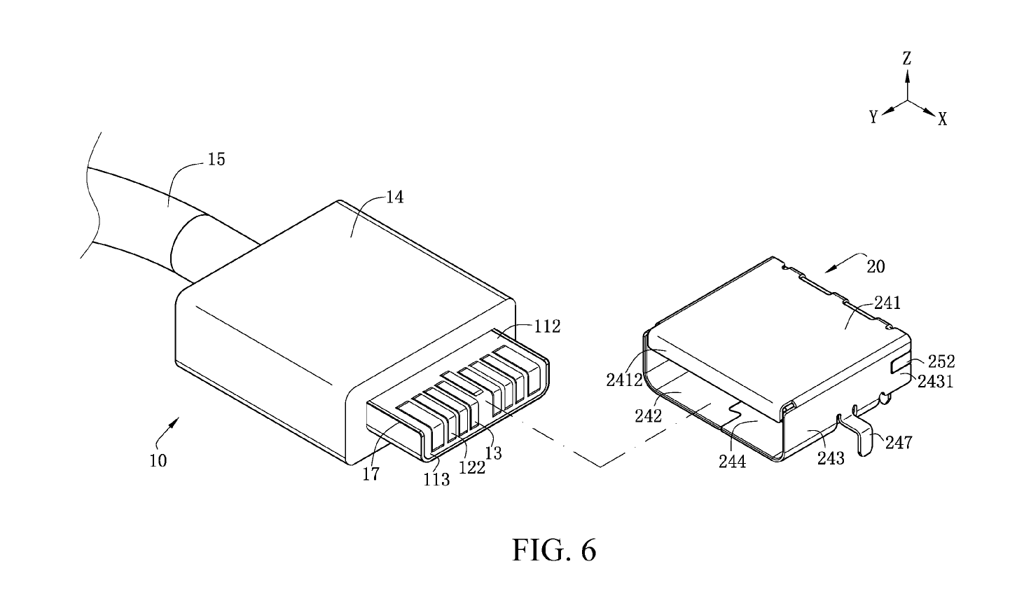

FIGS. 6-8 show a second embodiment of the present invention. This embodiment is the same as the first embodiment in the structure of the receptacle connector 20, which will not be repeated herein, and is different in the plug connector 10. In this embodiment, the first magnetic element 13 is plated on the bent portions 122. That is, the first magnetic element 13 is formed by magnetized metal plating and is disposed at front ends of the bent portions 122. The bent portions 122 are exposed out of the front surface 113, a metal case 17 is covered on the bottom surface 114 of the body 11, and the first mating surface 112 and the front surface 113 are exposed out of the metal case 17. The metal case 17 may be a magnetic element, and may also be a non-magnetic element. The body 11 and the metal case 17 are assembled and then covered by an insulating case 14 on the periphery. The insulating case 14 is also covered on the connection part of the cables 15 that are in electrical connection to the first terminals 12.

When the plug connector 10 is mated with the receptacle connector 20, the body 11 is inserted in the receiving space 244, and the first magnetic element 13 is magnetically attracted to the second magnetic element 23 by crossing the second contact portions 221, so that the first contact portions 121 and the second contact portions 221 are in stable electrical contact.

In view of the above, the electrical connector assembly according to certain embodiment of the present invention, among other things, has the following beneficial advantages.

(1) In the electrical connector assembly, magnetic attraction between the first magnetic element 13 and the second magnetic element 23 enables electrical connection between the plug connector 10 and the receptacle connector 20, which is easy to operate and convenient to use.

(2) By using connection through magnetic attraction between the magnetic elements to replace connection through engagement of buckling members, the structure is simple, and the simplified structure of the connector is more suitable for the developing trend of being smaller and thinner.

(3) By using connection through magnetic attraction between the magnetic elements, unintentional touch of the plug connector and the receptacle connector in use may cause immediate disconnection easily, which avoids problems of poor contact such as intermittent contact.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector assembly, comprising a plug connector and a receptacle connector mated in a forward and backward direction, wherein the plug connector comprises:
a body, having a first mating surface and a front surface disposed at a front end of the first mating surface; and
at least one first magnetic element disposed on the front surface; and
wherein the receptacle connector is located in front of the plug connector, and comprises:
a seat;
a second magnetic element, disposed on the seat and magnetically attracted to the first magnetic element, so that the plug connector and the receptacle connector are fixed; and
a second tongue, extending backward from the seat and having a second mating surface, wherein the second magnetic element is located at a front side of the second mating surface,
wherein the first magnetic element is magnetically attracted to the second magnetic element by crossing the second mating surface, so that the second mating surface is electrically connected with the first mating surface.

2. The electrical connector assembly according to claim 1, wherein the front surface is perpendicular to the first mating surface.

3. The electrical connector assembly according to claim 1, further comprising multiple first terminals disposed on the body, wherein the first magnetic element is located at front ends of the first terminals.

4. The electrical connector assembly according to claim 3, wherein each first terminal has a first contact portion, the first contact portion is perpendicular to the first magnetic element, and when the plug connector is mated with the receptacle connector, the insertion depth of the first magnetic element in the receptacle connector is greater than that of the first contact portions.

5. The electrical connector assembly according to claim 4, wherein the first contact portion is disposed on and exposed out of the first mating surface, the first contact portion is bent forwardly and downwardly, and extends to form a bent portion, and the bent portion is disposed on the body.

6. The electrical connector assembly according to claim 5, wherein the first magnetic element is plated on a front end of the bent portion.

7. The electrical connector assembly according to claim 1, further comprising multiple second terminals disposed on the second tongue, wherein each second terminal has a second contact portion, and the second magnetic element is located in front of the second contact portions in a forward and backward direction.

8. The electrical connector assembly according to claim 7, wherein the second terminals and the second magnetic element are disposed on the same side of the second tongue.

9. The electrical connector assembly according to claim 1, further comprising a shielding case disposed on the periphery of the seat, wherein the shielding case has a back flange, and the back flange is covered on a back end of the second tongue.

10. An electrical connector assembly, comprising a plug connector and a receptacle connector mated in a forward and backward direction,
wherein the plug connector comprises:
an insulating body, having a first mating surface and a front surface disposed at a front end of the first mating surface;
multiple first terminals, each having a first contact portion disposed on the first mating surface; and
at least one first magnetic element, disposed on the front surface; and
wherein the receptacle connector comprises:
a seat, having a second tongue;
a second magnetic element, disposed on the seat; and
multiple second terminals, each having a second contact portion disposed on the second tongue,
wherein when the plug connector is mated with the receptacle connector, the first magnetic element is magnetically attracted to the second magnetic element by crossing the second contact portions, so that the first contact portions electrically contact the second contact portions.

11. The electrical connector assembly according to claim 10, wherein the first magnetic element is perpendicular to the first contact portions.

12. The electrical connector assembly according to claim 10, wherein the second terminals and the second magnetic element are disposed on the same side of the second tongue.

13. The electrical connector assembly according to claim 10, wherein each first contact portion is bent forwardly and downwardly, and extends to form a bent portion, and the first magnetic element is plated on a front end of the bent portion.
